(19) United States
(12) Patent Application Publication
(10) Pub. No.: US 2013/0019029 A1
(43) Pub. Date: Jan. 17, 2013

(54) LOSSLESS COMPRESSION OF A PREDICTIVE DATA STREAM HAVING MIXED DATA TYPES

(71) Applicants: Ashish Jagmohan, Irvington, NY (US); Luis A. Lastras-Montano, Cortlandt Manor, NY (US)

(72) Inventors: Ashish Jagmohan, Irvington, NY (US); Luis A. Lastras-Montano, Cortlandt Manor, NY (US)

(73) Assignee: INTERNATIONAL BUSINESS MACHINES CORPORATION, Armonk, NY (US)

(21) Appl. No.: 13/181,860

(22) Filed: Jul. 13, 2011

(51) Int. Cl. G06F 15/16

(52) U.S. Cl. 709/247

(57) ABSTRACT

Lossless compression of a data stream having mixed data types, including a method for receiving a data stream that includes a plurality of different types of bit groups. Bit groups of at least two different types are extracted from the data stream to form a sub-stream. Circular shifts of the sub-stream are generated and then sorted into a sorted list of circular shifts. A transformed string that includes a bit group from each of the circular shifts is extracted from the sorted list of circular shifts. A location in the transformed string of a bit group from a pre-determined location in the sub-stream is identified. The transformed string is partitioned between the at least two different types of bit groups into transformed string partitions, and the transformed string partitions are compressed to form compressed transformed string partitions. The compressed transformed string partitions and the location are output.

### BACKGROUND

The present invention relates generally to data compression, and more specifically to lossless compression of a data stream having mixed data types.

One example of a data stream with mixed data types is floating-point data, where a sample has exponent and mantissa bits. An example of a floating-point data stream is seismic data. The processing of seismic data involves the acquisition and analysis of fields of subsurface data, acquired through reflective seismic waves. With improvements in acquisition modalities, the amount of data to be stored and processed is increasing at a rapid rate. An example data field may be terabytes in size and may need to be stored for several months for analysis. The large size of such fields imply a large cost for transmission and storage, as well as computational costs during analysis since the data has to be moved to and from computational cores. Compression of seismic data can mitigate these costs, and the ability to achieve a high level of compression is of great interest in this area. Seismic data tends to be floating-point data, and is typically required to be compressed losslessly so that information that may be of use during analysis is not discarded during compression.

### SUMMARY

An embodiment is a method for receiving a data stream that includes a plurality of different types of bit groups. Bit groups of at least two different types are extracted from the data stream to form a sub-stream. Circular shifts of the sub-stream are generated and then sorted into a sorted list of circular shifts. A transformed string that includes a bit group from each of the circular shifts is extracted from the sorted list of circular shifts. A location in the transformed string of a bit group from a pre-determined location in the sub-stream is identified. The transformed string is partitioned between the at least two different types of bit groups into transformed string partitions, and the transformed string partitions are compressed to form compressed transformed string partitions. The compressed transformed string partitions and the location are output.

Another embodiment is a system that includes an encoder configured for receiving a data stream that includes a plurality of different types of bit groups. Bit groups of at least two different types are extracted from the data stream to form a sub-stream. Circular shifts of the sub-stream are generated and then sorted into a sorted list of circular shifts. A transformed string that includes a bit group from each of the circular shifts is extracted from the sorted list of circular shifts. A location in the transformed string of a bit group from a pre-determined location in the sub-stream is identified. The transformed string is partitioned between the at least two different types of bit groups into transformed string partitions, and the transformed string partitions are compressed to form compressed transformed string partitions. The compressed transformed string partitions and the location are output.

Another embodiment is a computer program product that includes a tangible storage medium readable by a processing circuit and storing instructions for execution by the processing circuit for performing a method. The method includes receiving a data stream that includes a plurality of different types of bit groups. Bit groups of at least two different types are extracted from the data stream to form a sub-stream. Circular shifts of the sub-stream are generated and then sorted into a sorted list of circular shifts. A transformed string that includes a bit group from each of the circular shifts is extracted from the sorted list of circular shifts. A location in the transformed string of a bit group from a pre-determined location in the sub-stream is identified. The transformed string is partitioned between the at least two different types of bit groups into transformed string partitions, and the transformed string partitions are compressed to form compressed transformed string partitions. The compressed transformed string partitions and the location are output.

Another embodiment is a method for receiving a data stream that includes a plurality of different types of bit groups. A training segment is extracted from the data stream. The training segment is compressed using a plurality of different algorithms. At least one of the compression algorithms extracts bit groups of one or more types from the training segment to form a first sub-stream, generates a transformed sub-stream using circular shift generation and lexicographic sorting, partitions the transformed sub-stream responsive to bit-group type, compresses the partitions, extracts bit-groups of a type not included in the first sub-stream, orders the extracted bit-groups of a type not included in the first sub-stream in response to an ordering of the transformed sub-stream, and compresses the ordered bit-groups. An actual compression rate and an actual compression speed are determined for each of the compression algorithms responsive to the compressing. A compression algorithm for the data stream is selected from the plurality of different compression algorithms. The selecting is responsive to the actual compression rate, the actual compression speed, and at least one of a target compression rate and a target compression speed. The data stream is compressed using the selected compression algorithm.

A further embodiment is a method for receiving a data stream that includes a plurality of different types of bit groups. Bit groups of one type are extracted from the data stream to form a sub-stream. Circular shifts of the sub-stream are generated and then sorted into a sorted list of circular shifts. A transformed string that includes a bit group from each of the circular shifts is extracted from the sorted list of circular shifts. A location in the transformed string of a bit group from a pre-determined location in the sub-stream is identified. The transformed string is compressed to form a compressed transformed string. The compressed transformed string is output along with the location in the transformed string of the bit group from the pre-determined location in the sub-stream. Bit groups of a least one type not included in the sub-stream are extracted from the data stream to form a conditional sub-stream. The conditional sub-stream is ordered responsive to an order of the sorted list of circular shifts, to form a transformed conditional string. The transformed conditional string is compressed to form a compressed transformed conditional string and the compressed transformed conditional string is output.

A further embodiment is a method for receiving a data stream that includes a plurality of different types of bit groups. Bit groups of one type are extracted from the data stream to form a sub-stream. Circular shifts of the sub-stream are generated and then sorted into a sorted list of circular shifts. A transformed string that includes a bit group from each of the circular shifts is extracted from the sorted list of circular shifts. A location in the transformed string of a bit group from a pre-determined location in the sub-stream is identified. The transformed string is compressed to form a compressed transformed string. The compressed transformed string is output along with the location in the transformed string of the bit group from the pre-determined location in the sub-stream. Bit groups of a least one type not included in the sub-stream are extracted from the data stream to form a second sub-stream. Circular shifts of the second sub-stream are generated and sorted into second sub-stream circular shifts. A second transformed string is extracted from the second sub-stream sorted circular shifts. The second transformed string includes a bit group from each of the circular shifts of the second sub-stream. The second transformed string is compressed to form a compressed second transformed string and the compressed second transformed string is output.

Additional features and advantages are realized through the techniques of the present embodiment. Other embodiments and aspects are described herein and are considered a part of the claimed invention. For a better understanding of the invention with the advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a block diagram of a system for encoding and decoding data in a memory system in accordance with an embodiment;

FIG. 2 illustrates a block diagram of a system for encoding and decoding data for transmission across a network in accordance with an embodiment;

FIG. 3 illustrates an example of a Burrows-Wheeler transform (BWT) compression process;

FIG. 4 illustrates a compression process that partitions the output of a BWT in accordance with an embodiment;

FIG. 5 illustrates a compression process that utilizes a multi-stage BWT with type-dependent contexts in accordance with an embodiment;

FIG. 6 illustrates a compression process that utilizes a BWT with type-dependent contexts in accordance with an embodiment;

FIG. 7 illustrates a compression process that utilizes a multi-stage BWT with type-dependent contexts in accordance with an embodiment;

FIG. 8 illustrates a block diagram of an encoder for encoding and compressing data in accordance with an embodiment; and

FIG. 9 illustrates a block diagram of a process for adaptive algorithm selection in accordance with an embodiment.

### DETAILED DESCRIPTION

An embodiment is directed to Burrows-Wheeler transform (BWT) based compression of floating-point data that factors in the different kinds of bytes contained in floating-point data. The BWT transforms a data string by lexicographically sorting the cyclic permutations of the string in a table, and then selecting a pre-determined column of the sorted table. For example, the lexicographic sorting may be done left to right, and the last column may represent the transformed string. The sorted table is also referred to, herein, as a sorted list. The transformed string is a permutation of the original data string. In an embodiment, the floating-point data is treated as being made up of bytes/bit-groups of various types, such as a bit-group containing the exponent and sign bits, another group containing the eight most significant mantissa bits, another group containing the eight next most significant mantissa bits, and so on. By factoring in an awareness of the different types of bit-groups into the transform(s) applied to the original data, increased compression ratios and/or increased compression speed is achieved. Different types of context models (modeling dependencies between the types of bit-groups) give rise to different algorithmic transforms (also termed ‘algorithms’ or simply ‘transforms’); these, taken together, constitute a family of possible transforms. Depending on the actual model of the underlying data, a particular algorithmic transform is selected. An embodiment of an algorithm described herein adaptively selects the best (e.g., in terms of compression ratio and/or speed) transform to use for the underlying data as it is compressing the data.

In an embodiment, each floating-point data sample is assumed to be separable into a byte containing the sign bit and the exponent bits (such a byte is termed an ‘exponent byte’); a byte containing the eight most significant mantissa bits; a byte containing the eight next-most significant mantissa bits; and so on. For many types of floating-point data, a good compression ratio can be achieved by using as the context of an exponent byte the temporally preceding exponent bytes, using as the context of a most significant (MS) mantissa byte the temporally preceding exponent bytes, using as the context for a next MS mantissa byte the temporally preceding MS mantissa and exponent bytes, and so on. An embodiment described herein uses a sequence of BWT operations, wherein the sequence of operations is designed so as to leverage such contexts to effectively compress the data.

Embodiments described herein seek to leverage the fact that a source floating-point sequence includes different types of bytes (or bit-groups) and that the ‘predictive set’ for each type may be different and dependent on the type. A predictive set for a given byte/bit-group is defined as a set of temporally preceding bytes/bit-groups, which serve as a good predictive context for the given byte/bit-group. One first approach used by embodiments is to partition the transformed data string on the basis of type to improve post-transform compression. A second approach is to design the transform to incorporate different implicit contexts based on symbol-type. A third approach is to perform a multi-stage transform to improve on the effectiveness of the second approach. Depending on how these three approaches are combined, different algorithms/transforms result. Considerations to be taken into account when selecting a transform include trade-offs between compression throughput and compression ratio. The selection of which transform to utilize may be done off-line or adaptively.

In accordance with one embodiment, exponent bytes are extracted from a floating-point string (also referred to herein as source floating-point data sequence) being compressed; a BWT table is constructed for the exponent string, and the BWT transformed string is compressed. The MS mantissa byte string corresponding to the order of the exponents in the first column of the BWT table that was constructed for the exponent string is compressed and appended to the compression output stream. Next, a BWT table of the string formed by the exponent and MS mantissa bytes extracted from the original source data is constructed. The next MS mantissa byte string corresponding to the order of the exponents in the first column of the BWT table that was constructed for the exponent and the MS mantissa is compressed, and appended to the compression output stream. This process is continued until all bytes are compressed. Also output is the index of the row in the exponent BWT table in which the original exponent byte string occurs.

In an alternative embodiment, the BWT of the entire input string is constructed, and the transformed string is partitioned based on the type of byte. Each sub-string thus generated is separately compressed, and the encoder additionally outputs partition information.

In an embodiment, different algorithms, such as those described above and possibly others, are tried on a first small partition of the data, and the best-performing algorithm is then used for compressing the next “X” number of bytes of data (where X is pre-specified). This process is periodically repeated, either at predetermined intervals, or when the per-byte compression ratio being achieved has changed by a sufficient pre-specified amount. This allows the compression process to adaptively select the best compression algorithm for various parts of source floating-point sequence of data in response to characteristics of the data.

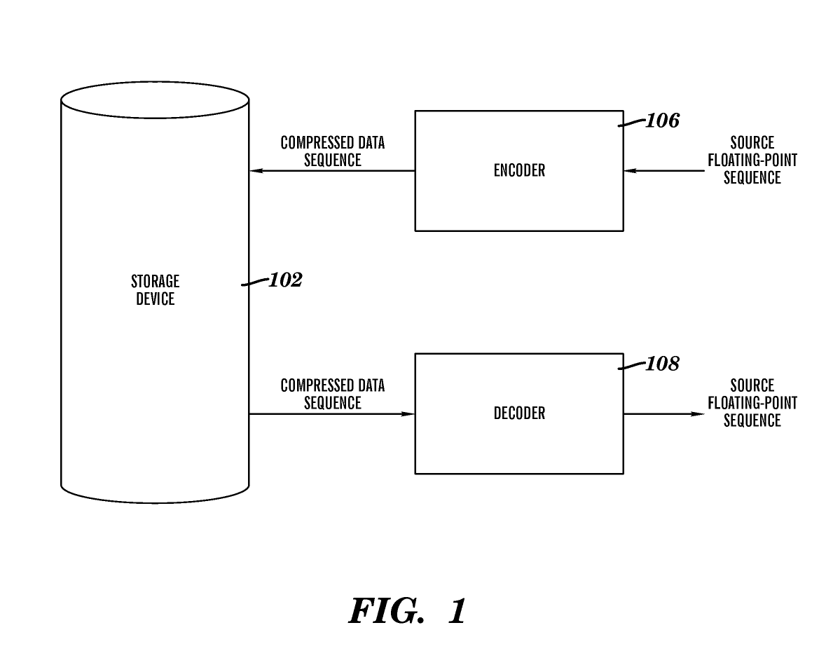

FIG. 1 illustrates a block diagram of a system for encoding and decoding data in a memory system in accordance with an embodiment. The system depicted in FIG. 1 includes a storage device 102 which may be implemented by memory internal to a processor such as main memory or cache, by a stand-alone storage device such as a hard disk drive (HDD), or by any other type of storage medium. FIG. 1 also includes an encoder 106 for receiving and encoding a source floating-point sequence (also referred to herein as a “data stream”), and for outputting a compressed data sequence for storage in the storage device 102. The system in FIG. 1 also includes a decoder 108 for receiving the compressed data sequence from the storage device 102 and for generating the source floating-point sequence from the compressed data sequence.

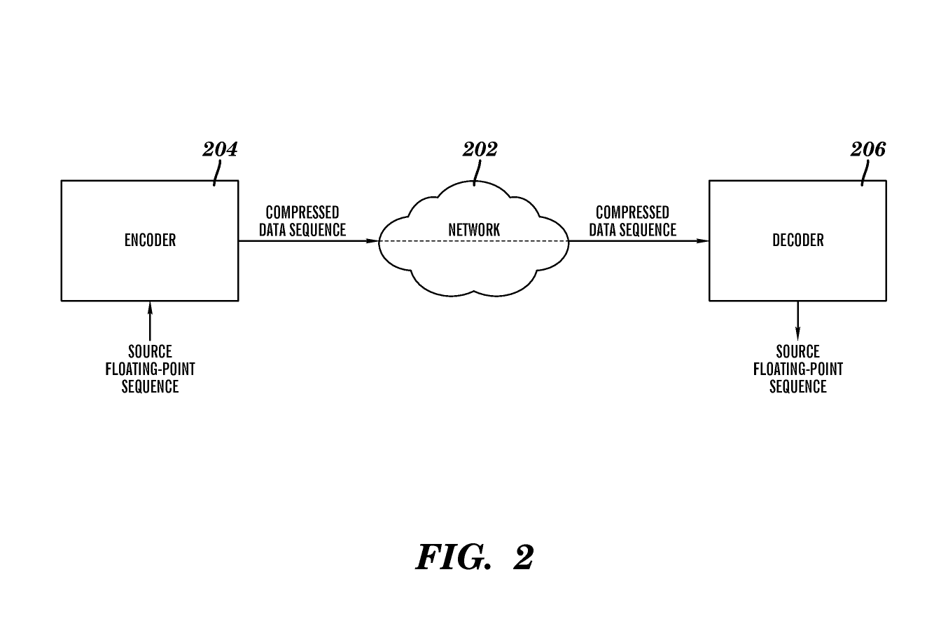

FIG. 2 illustrates a block diagram of a system for encoding and decoding data for transmission across a network (or other transmission medium) in accordance with an embodiment. FIG. 2 includes an encoder 204 for compressing a source floating-point sequence, a network 202 for transmitting the compressed data sequence, and a decoder 206 for generating the original source floating-point sequence from the compressed data sequence. The network 202 shown in FIG. 2, may be implemented by any type of network known in the art, such as but not limited to a wired network, a wireless network, a cellular network, an intranet, the Internet, a local area network (LAN), and a wide area network (WAN). In an embodiment the network 202 is a bus or other transmission medium that directly connects the encoder 204 to the decoder 206.

In an embodiment, the encoding/compression algorithms used for a communication system, such as that shown in FIG. 2, are the same algorithms as those used in a storage system, such as that shown in FIG. 1. In another embodiment, the different constraints in different types of systems are taken into account and the encoding/compression algorithms are different.

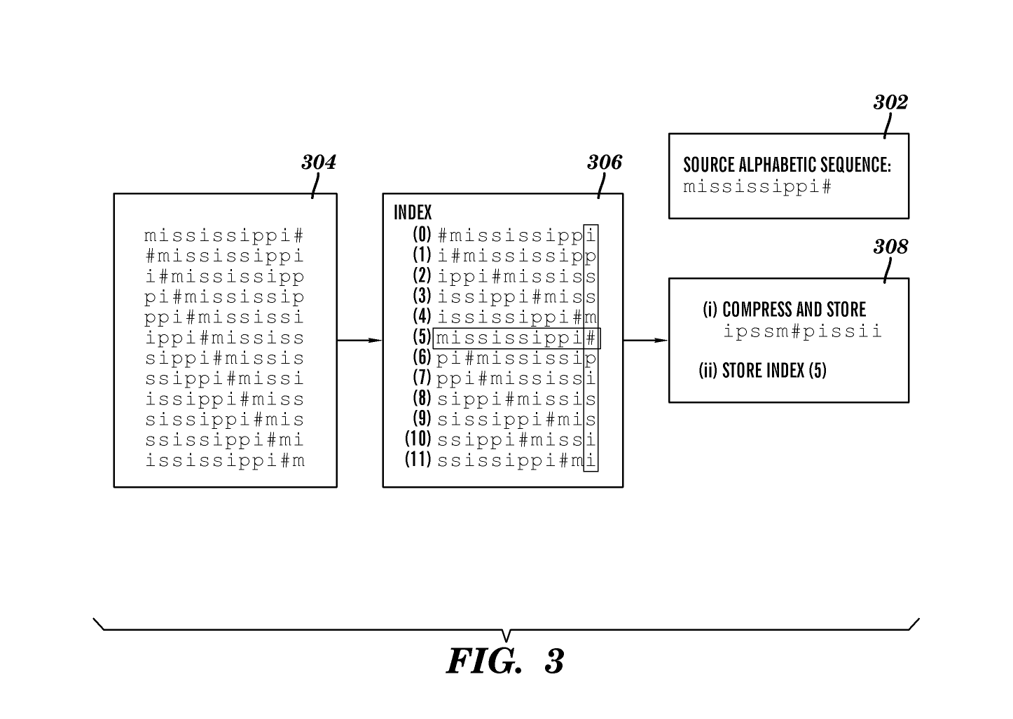

FIG. 3 illustrates an example of a standard BWT operation used in the process of performing lossless data compression. In exemplary embodiments described herein, the process of lossless compression of floating-point data includes the use of one or more BWT operations. As shown in FIG. 3, an input to the BWT is a sequence of symbols (in this example, for illustrative purposes, the symbols are alphabetic characters). The example source alphabetic sequence in block 302 of FIG. 3 is the string “mississippi#” (where # is an end of sequence symbol). At block 304, all circular shifts of the sequence are enumerated in a table. As used herein, the term “circular shifts” refers to strings generated by shifting all of the symbols in a string, S, left or right by an amount, P. If the circular shifts are left circular shifts, then the leftmost P symbols are moved to the end of the string in each circular shift. If the circular shifts are right circular shifts, then the rightmost P symbols are moved to the front of the string in each circular shift. The string S in FIG. 3 is “mississippi#” and each of the twelve circular shifts shown in block 304 move the symbols to the right by one symbol (P=1) and append the rightmost symbol to the front of the string (e.g., in one shift “#mississippi” becomes “i#mississipp”).

At block 306, the table is sorted lexicographically (e.g., alphabetically in this case). As known in the art, lexicographic or lexicographical order (also referred to as lexical order, dictionary order, alphabetical order or lexicographic(al) product) is a generalization of the way the alphabetical order of symbols is based on the alphabetical order of letters.

At block 308, the last column in the resultant sorted table (the column referred to herein as a “permuted string” or a “transformed string”) shown in block 306 is losslessly compressed. The main advantage of using the BWT operation is that the transformed string is easier to compress, in that it can be effectively compressed by using computationally simple techniques such as a simple move-to-front (MTF) type compressor, or a low-order Huffman compressor or a simple arithmetic compressor with a small amount of state. The sixth row of the table in block 306, having an index value of (5) is identified as containing the source alphabetic sequence that was input as shown in block 302. The compressed column and the index value of (5) constitute the compressed data output from the compression process shown in FIG. 3. The output may be stored in a storage medium and/or transmitted to a receiver/requestor via a transmission medium. Those skilled in the art will appreciate that a decoder using the same BWT algorithm as the encoder will be able generate the source alphabetic sequence from the compressed column and the index value.

The last column of the table in block 306 is the BWT output i.e., the last column constitutes the transformed or permuted string. It is relatively easy to compress, in that it can be effectively compressed using simple algorithms such as MTF and/or run-length (RL) encoding followed by low-order entropy (Huffman/arithmetic) coders. One reason that the last column in block 306 is easy to compress is that neighboring symbols in the last column effectively correspond to similar temporal contexts, and are hence likely to be identical. Compression algorithms based on the BWT have the advantage of providing effective compression at fast speeds, since high-order context modeling does not need to be done explicitly. However, when applied directly to floating-point data, the BWT can be inefficient (i.e., the output of the BWT may not compress very well) since it does not distinguish between the different types of bytes (exponent, mantissa bytes of differing significance etc.). Embodiments described herein provide methods for effectively compressing floating-point data using one or more BWT operations by taking into account the different types of bytes.

In an embodiment described herein, a floating-point number sequence is assumed to include four different types of bytes: the exponent and sign byte (referred to herein as “E”), the MS mantissa byte (referred to herein as “M”), the next MS mantissa byte (referred to herein as “N”), and the least significant (LS) mantissa byte (referred to herein as “O”). Embodiments described herein can be straightforwardly applied to other floating-point number formats as well. For purposes of discussion herein, a string of floating-point numbers includes a sequence of 4-byte-tuples (E, M, N, and O). Thus, a single-precision (32-bit) floating-point stream with “n” samples can be represented as:)) E₍₀₎M₍₀₎N₍₀₎O₍₀₎E₍₁₎M₍₁₎N₍₁₎O₍₁₎ . . . E₍ₙ₋₁₎M₍ₙ₋₁₎N₍ₙ₋₁₎O₍ₙ₋₁₎ where E are exponent bytes and M, N, and O, are the three different types of mantissa bytes. As referred to herein, each individual byte, E, M, N, and O, makes up a single symbol, and thus each single-precision-floating-point number (or data point) is made up of four symbols (E, M, N, and O).

Floating-point data has at least two characteristics that make conventional BWT based compression relatively ineffective. First, floating-point data includes bytes having different types. Second, effective prediction of a symbol of a given type may require the use of a specific subset of a symbol's context, rather than the whole context, and this subset may be type dependent. For example, exponent bytes may be best predicted by other exponent bytes, rather than by the three mantissa bytes that together with the exponent byte make up a floating-point number. Thus, the useful predictive set for E₍ᵢ₎ may be “E⁽ⁱ⁺¹⁾E⁽ⁱ⁺²⁾ . . . ” rather than the entire context “M⁽ⁱ⁾N⁽ⁱ⁾O⁽ⁱ⁾E^{(i+1)M}⁽ⁱ⁺¹⁾ . . . ”. Similarly, mantissa bytes may be best predicted by exponents and higher-order mantissa bytes. Thus, the useful predictive set for N⁽ⁱ⁾ may be “E⁽ⁱ⁾M⁽ⁱ⁾E^{(i+1)M}⁽ⁱ⁺¹⁾ . . . ”. Trivially splitting the stream into four and using four BWTs would not handle this second case because it would not take into account inter-type dependencies (e.g., high-order mantissas may be well-predicted by exponents).

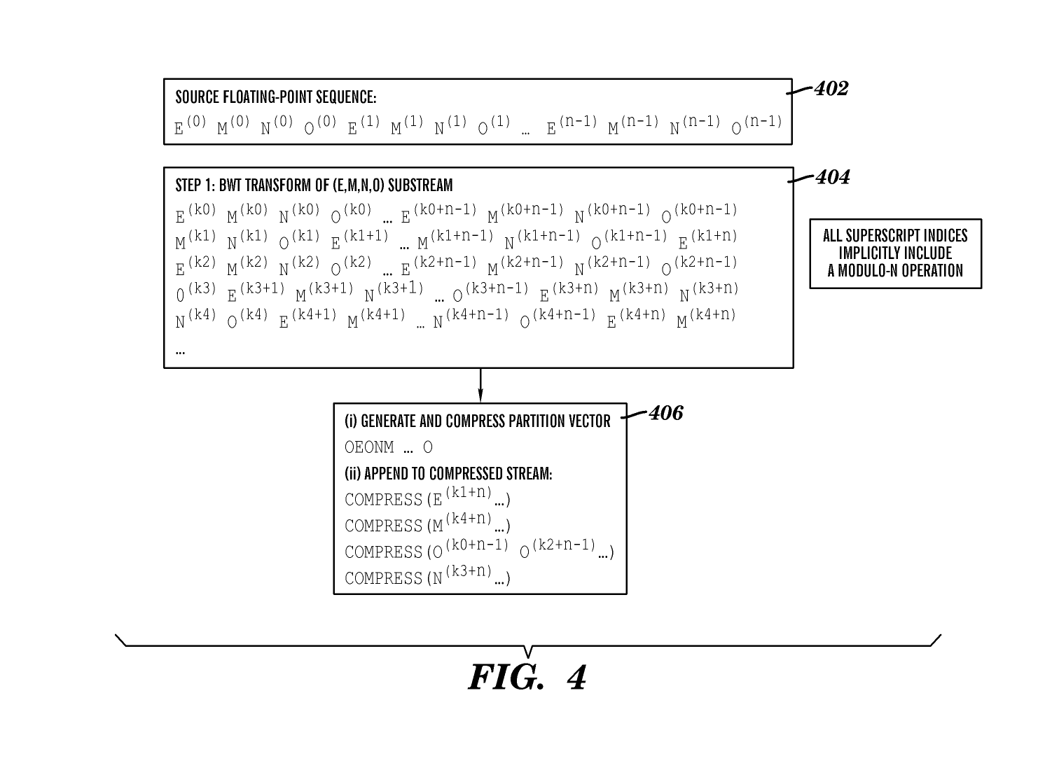

FIG. 4 illustrates a compression process that partitions the output of a BWT in accordance with an embodiment. In an embodiment, the compression process depicted in FIG. 4 is implemented on an encoder, such as encoder 106 or encoder 204. Block 402 of FIG. 4 depicts a source floating-point sequence having “n” data samples.

For purposes of illustration, each byte type (or bit group) shown in FIG. 4 is assumed to include eight bits, however, it should be noted that each bit group may also be more than eight bits or less than eight bits. In the embodiment shown in FIG. 4, a BWT of the sequence is performed, with a table such as that shown in block 404 being the result of performing the circular shift and lexicographic sorting of the BWT. A standard BWT compression process would output a compressed version of the last column of the table shown in block 404 as well as the index value that corresponds to the location of the source floating-point sequence in the table.

In the embodiment shown in FIG. 4, additional processing is performed to provide a more compressed output than that resulting from the standard BWT based compression process. A partition vector as shown in block 406 is generated and compressed that indicates what type of bit group (or byte type) is located at each position in the last column of the table shown in block 404. Thus, for example, since the last symbol in row 1 of the last column is of type O, the first element of the partition vector is an O. Similarly since the second element of the last column (i.e., the last symbol in row 2) is of type E, the second element of the partition vector is an E. The last column in FIG. 4 is referred to herein as a “permuted string” or as a “transformed string.” Also generated and appended to the compressed partition vector, and as shown in block 406, is a compressed string including all of the exponent bytes in the last column of the BWT table (in the order of appearance in the BWT table) shown in block 404, a compressed string including all of the MS mantissa bytes in the last column of the BWT table (in the order of appearance in the last column of the BWT table), a compressed string including all of the next MS mantissa bytes in the last column of the BWT table (in the order of appearance in the last column of the BWT table), and a compressed string including all of the LS mantissa bytes in the last column of the BWT table (in the order of appearance in the last column of the BWT table).

In an embodiment, the string compression is performed using a simple move-to-front, run-length coding and adaptive low-order Huffman or arithmetic coding (as is well-known in the art) or any other suitable compression algorithm known in the art. The embodiment results in better compression than the conventional BWT process because the strings generated in the embodiment are partitioned by type. Strings of the same type can be compressed more effectively (than strings of different types) by simple low model-order compressors. The partition vector and compressed strings including the exponent, MS mantissa, next MS mantissa, and LS mantissa bytes are output from the process shown in FIG. 4. Also output, though not shown in the figure, is an index value corresponding to the row in the BWT table that is identical to the source data sequence.

Thus, in the embodiment shown in FIG. 4, the last column in the BWT table shown in block 404 is partitioned by byte-type, and the compressed output includes: (i) A partition vector which indicates the type of each byte in the last column of the BWT table, (ii) an index value for the row in the BWT table that starts with E⁽⁰⁾, and (iii) separately compressed subsequences that include E, M, N and O type bytes in the order of appearance in the last column of the BWT table.

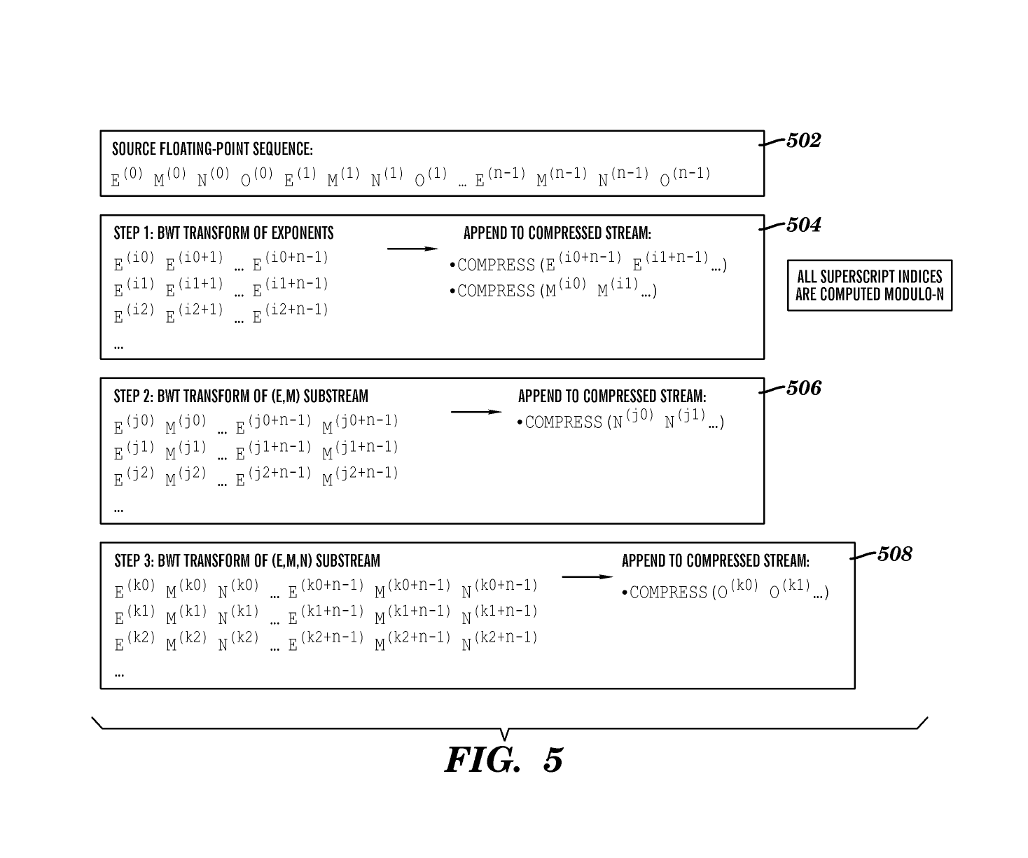

FIG. 5 illustrates a compression process with type-dependent contexts that uses multiple BWT operations in accordance with an embodiment. In an embodiment, the compression process depicted in FIG. 5 is implemented on an encoder, such as encoder 106 or encoder 204. In the embodiment shown in FIG. 5, additional processing is performed to provide a more compressed output than that resulting from the BWT compression process shown in FIG. 4.

Block 502 of FIG. 5 depicts a source floating-point sequence having “n” data samples. The processing shown in block 504 assumes that a predictive subset for E⁽ⁱ⁾ is E⁽ⁱ⁺¹⁾E⁽ⁱ⁺² . . . and that a predictive subset for M⁽ⁱ⁾ is E⁽ⁱ⁾E⁽ⁱ⁺¹⁾ . . . . Thus, the context of the M-type bytes is effectively the temporally neighboring exponents, which allows for effective compression. As shown in block 504, a sub-stream containing the exponent bytes is extracted, and the BWT transform table is generated (lexicographically ordered, with the first column having priority). In an embodiment, the compressed output of block 504 is the last column of exponents compressed using a simple move-to-front, run-length coding and adaptive low-order Huffman or arithmetic coding (as is well-known in the art); and the string of MS mantissas (M-type bytes) ordered corresponding to the ordering of the first column of the BWT table are compressed using similar algorithms. Here the correspondence can be understood as follows. Since the first byte of the first column is E⁽ⁱ⁰⁾, the first byte in the ordered MS mantissa string is the corresponding mantissa byte M⁽ⁱ⁰⁾. Similarly, the second byte in the ordered MS mantissa string is the byte M⁽ⁱ¹⁾ which corresponds to the second exponent byte E⁽ⁱ¹⁾ in the first column of the BWT table in 504.

The processing shown in block 506 assumes that a predictive subset for N⁽ⁱ⁾ is E⁽ⁱ⁾M⁽ⁱ⁾E⁽ⁱ⁺¹⁾M⁽ⁱ⁺¹⁾ . . . . As shown in block 506, the sub-stream corresponding to (E,M) tuples is extracted and the BWT is performed on it (with only the cyclically shifted sequences beginning with E-type bytes used). The compressed output of this step is the compressed stream of N-type bytes corresponding to the first column of E-type bytes in the BWT table.

In an embodiment, this process is continued until all types of bytes have been compressed. For example in block 508, the BWT table corresponds to the (E, M, N) subsequence, and the output is compressed O-type bytes. The processing shown in block 508 assumes that a predictive subset for O⁽ⁱ⁾ is E⁽ⁱ⁾M⁽ⁱ⁾N⁽ⁱ⁾E⁽ⁱ⁺¹⁾M⁽ⁱ⁺¹⁾N⁽ⁱ⁺¹⁾ . . . . The compression process further outputs the index value of the row, in the BWT table in 504, which begins with the first data exponent E⁽⁰⁾.

The contexts/predictive subsets described herein are intended to be exemplary in nature, as other contexts can be accounted for by different arrangements of the BWT transform and compressed output strings.

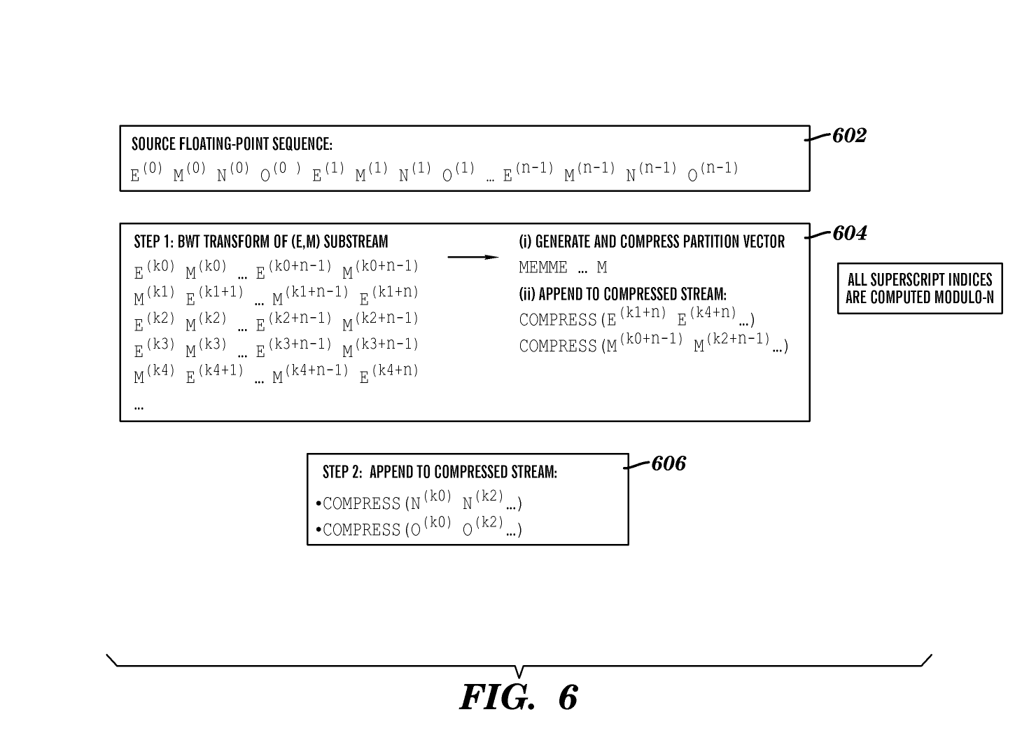

FIG. 6 illustrates a compression process that utilizes a BWT with type-dependent contexts in accordance with an embodiment. In an embodiment, the compression process depicted in FIG. 6 is implemented on an encoder, such as encoder 106 or encoder 204. FIG. 6 shows another embodiment illustrating how the methods described above can be integrated in into a single compression algorithm. The embodiment shown in FIG. 6 requires less processing than that shown in FIG. 5, but it may result in a lower compression ratio.

Block 602 of FIG. 6 depicts a source floating-point sequence having “n” data samples. In the algorithm in FIG. 6, the first step is a joint BWT of the (E, M) sub-stream. The processing shown in block 604 assumes that a predictive subset for E⁽ⁱ⁾ is M⁽ⁱ⁾E⁽ⁱ⁺¹⁾M⁽ⁱ⁺¹⁾E⁽ⁱ⁺²⁾ . . . and that a predictive subset for M⁽ⁱ⁾ is E⁽ⁱ⁺¹⁾M⁽ⁱ⁺¹⁾E⁽ⁱ⁺²⁾ . . . The last column is partitioned by byte-type into two partitions, and the compressed output of this step is: (i) a partition vector which indicates the type of each byte in the last column of the BWT table, (ii) and index value corresponding to the row in the BWT table that starts with E⁽⁰⁾, and (iii) separately compressed subsequences consisting of E and M type bytes in the order of appearance in the last column. Also appended to the compressed stream, and as shown in block 606, are compressed subsequences of N and O type bytes in the order of the E type bytes in the first column of the BWT table in block 604. Thus, this algorithm assumes that a predictive subset for N⁽ⁱ⁾ is E⁽ⁱ⁾M⁽ⁱ⁾E⁽ⁱ⁺¹⁾M⁽ⁱ⁺¹⁾ . . . and that a predictive subset for for O⁽ⁱ⁾ is E⁽ⁱ⁾M⁽ⁱ⁾E⁽ⁱ⁺¹⁾M⁽ⁱ⁻¹⁾ . . . .

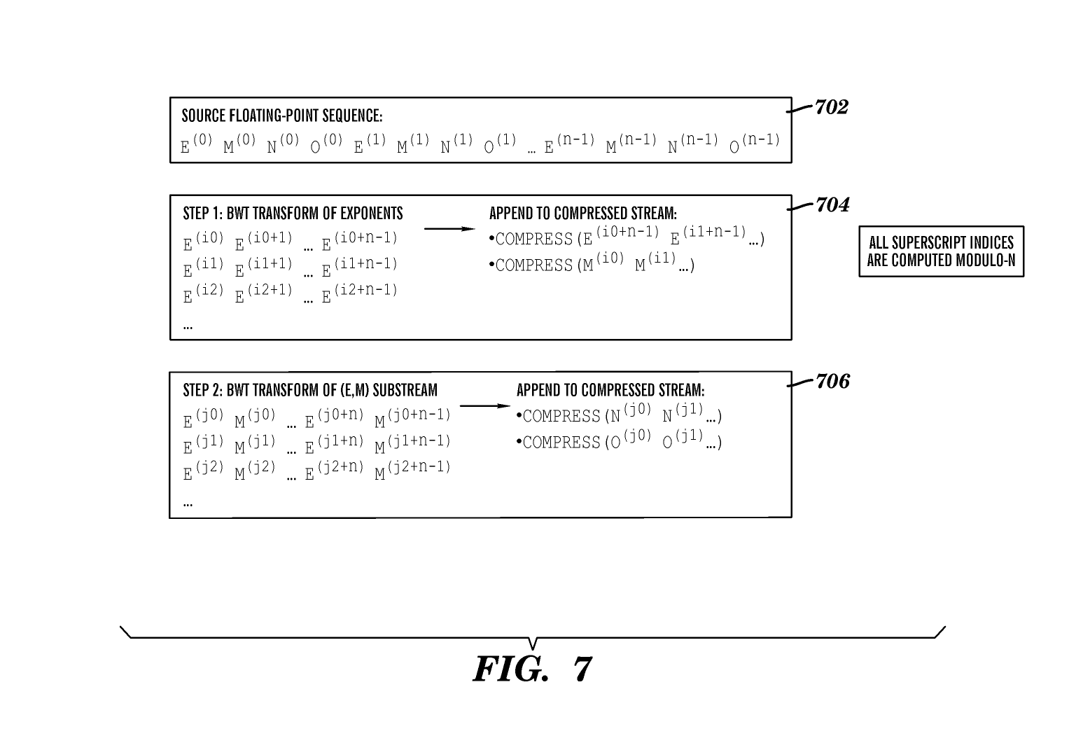

FIG. 7 illustrates a compression process that utilizes a multi-stage BWT with type-dependent contexts in accordance with an embodiment. In an embodiment, the compression process depicted in FIG. 7 is implemented on an encoder, such as encoder 106 or encoder 204.

Block 702 of FIG. 7 depicts a source floating-point sequence having “n” data samples. The processing shown in blocks 704 and 706 is similar to the processing described above with respect to blocks 504 and 506 in FIG. 5. In FIG. 7, the process termites after block 706 and the compressed output of block 706 is the compressed stream of N-type bytes, and a second compressed stream of 0-type bytes corresponding to the first column of E-type bytes in the BWT table.

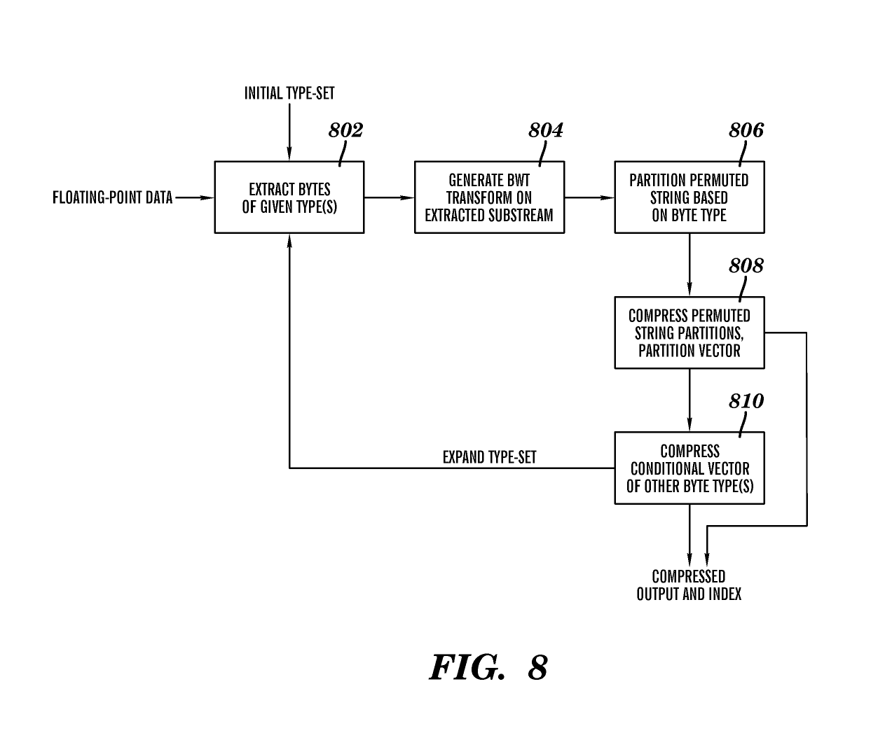

FIG. 8 illustrates a block diagram of a generalization of a process performed by an encoder for encoding and compressing data in accordance with embodiments. The process shown in FIG. 8 can be used to generate various BWT based algorithms, such as those shown in FIGS. 4-7, which may be suitable for various kinds of data. Given the floating-point data (e.g., source floating-point sequence) and a selected initial-type set, bytes from the initial-type set are extracted from the source floating-point sequence at block 802. For example, in the embodiments in FIG. 5 and FIG. 7, the initial type-set consists of type E, while in the embodiment in FIG. 6 the initial type-set consists of types E and M. As described herein, embodiments are not limited to a data stream of floating-point data, and data streams made up of bit groups of other types may be implemented by exemplary embodiments. At block 804, the BWT is generated on the extracted sub-stream, resulting in a transformed or permuted string. At block 806, the permuted string is partitioned based on byte-type. At block 808, the partition vector and the transformed or permuted string partition(s) are compressed and then output. In an alternate embodiment, such as the embodiment shown in FIG. 7, blocks 806 and 808 skipped. Processing continues at block 810, where a conditional vector(s) (also termed ‘conditional sub-stream’) of one or more byte types not included in the subset is extracted, ordered according to the ordering of the cyclically permuted strings in the BWT table, compressed and output. For example, in the embodiments in FIG. 5 and FIG. 7, in blocks 504 and 704, the conditional vector consists of all bytes of type M. The type-set may then be expanded and processing continues at block 802 for the expanded type set. Various embodiments of this generalized algorithm may skip one or more of these steps.

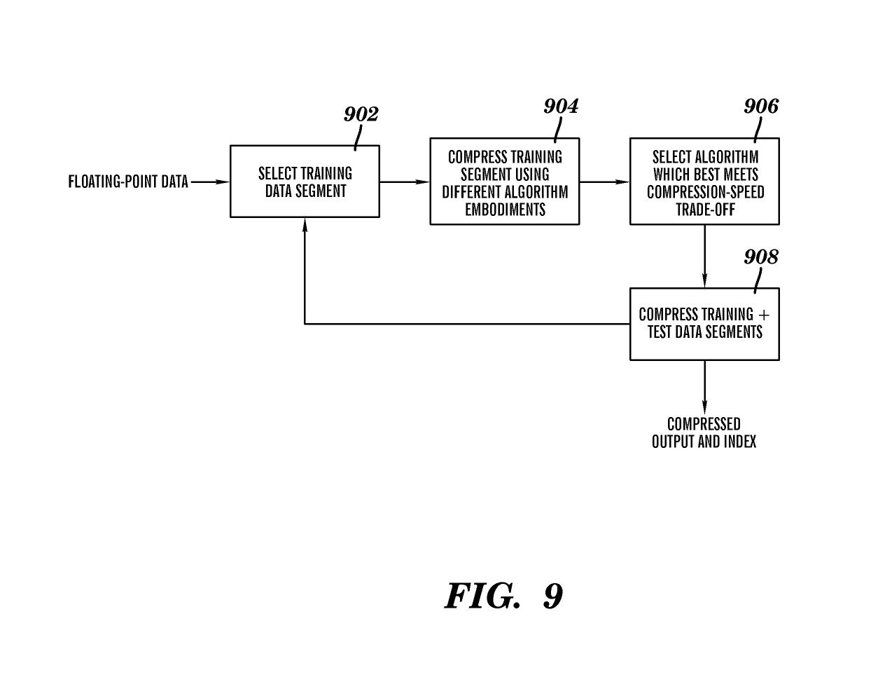

FIG. 9 illustrates a block diagram of a process for adaptive algorithm selection while compressing floating-point data in accordance with an embodiment. In an embodiment, the adaptive algorithm selection process depicted in FIG. 9 is implemented on an encoder, such as encoder 106 or encoder 204. At block 902, a first segment of the floating-point data is selected as training data, and at block 904, the various candidate BWT algorithms are used to encode it. Another input to the system is a speed/compression ratio requirement (e.g., a target compression speed and a target compression rate). At block 906, the algorithm that best meets the speed/compression requirements is selected from among the candidate BWT algorithms. At block 908, the selected algorithm is used to compress a next segment of the data and to produce the compressed output. In an embodiment, a new segment of the data is selected for training periodically and the algorithm can be changed based on the performance of the various algorithms on this new segment. In an embodiment, the new training is performed at regular intervals, or in another embodiment it is done when the performance of the currently selected algorithm has changed (in terms of compression ratio or speed) by a given amount.

Those skilled in the art will appreciate that a decoder that is aware of the compression algorithm utilized by the encoder will be able to generate the original data sequence. In an embodiment, the decoder receives a compressed data stream that includes the compressed index difference values.

Technical effects and benefits include the ability to factor in the different kinds of bytes contained in floating-point data when using a BWT transform, resulting in a higher compression ration. Additional effects and benefits include the ability to adaptively select a best (in terms of compression ratio and/or cost) BWT algorithm among several possible BWT algorithms.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flow diagrams depicted herein are just one example. There may be many variations to this diagram or the steps (or operations) described therein without departing from the spirit of the invention. For instance, the steps may be performed in a differing order or steps may be added, deleted, or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method comprising:
receiving a data stream comprising a plurality of different types of bit groups;
extracting bit groups of at least two different types from the data stream to form a sub-stream;
generating circular shifts of the sub-stream;
sorting the circular shifts of the sub-stream to form a sorted list of circular shifts;
extracting a transformed string from the sorted list of circular shifts, the transformed string comprising a bit group from each of the circular shifts;
identifying a location in the transformed string of a bit group from a pre-determined location in the sub-stream;
partitioning the transformed string between the at least two different types of bit groups into transformed string partitions;
compressing the transformed string partitions into compressed transformed string partitions;
outputting the compressed transformed string partitions; and
outputting the location in the transformed string of the bit group from the pre-determined location in the sub-stream.

2. The method of claim 1, further comprising:
generating a partition vector that identifies a type of bit group that occurs at each location of the transformed string;
compressing the partition vector to form a compressed partition vector; and
outputting the compressed partition vector.

3. The method of claim 1, further comprising:
extracting bit groups of at least one type not included in the sub-stream from the data stream to form a conditional sub-stream;
ordering the conditional sub-stream responsive to an order of the sorted list of circular shifts to form a transformed conditional string;
compressing the transformed conditional string to form a compressed transformed conditional string; and
outputting the compressed transformed conditional string.

4. The method of claim 3, wherein the ordering the conditional sub-stream is further responsive to an order of a sequence of bit-groups of a pre-determined type, the sequence of bit-groups generated by extracting, in order from the sorted list of circular shifts, each circular shift which begins with a bit-group of the pre-determined type, and extracting the first bit-group from each of these extracted circular shifts.

5. The method of claim 1, further comprising:
extracting bit groups of at least one type not included in the sub-stream from the data stream to form a second sub-stream;
generating circular shifts of the second sub-stream;
sorting the circular shifts of the second sub-stream into second sub-stream sorted circular shifts;
extracting a second transformed string from the second sub-stream sorted circular shifts, the second transformed string comprising a bit group from each of the circular shifts of the second sub-stream;
compressing the second transformed string to form a compressed second transformed string; and
outputting the compressed second transformed string.

6. The method of claim 1, further comprising compressing the location in the transformed string of the bit group from the pre-determined location in the sub-stream prior to outputting the location.

7. The method of claim 1, wherein the sorting is lexicographical.

8. The method of claim 1, wherein the generating, sorting, extracting a transformed string and identifying is performed using a Burrows-Wheeler Transform (BWT).

9. The method of claim 1, wherein the transformed string is formed from a last bit group in each circular shift of the sub-stream.

10. The method of claim 1, wherein the data stream comprises floating-point numbers, and the plurality of different types of bit groups include an exponent type and a plurality of mantissa types.

11. A system comprising:
an encoder configured for:
receiving a data stream comprising a plurality of different types of bit groups;
extracting bit groups of at least two different types from the data stream to form a sub-stream;
generating circular shifts of the sub-stream;
sorting the circular shifts of the sub-stream to form a sorted list of circular shifts;
extracting a transformed string from the sorted list of circular shifts, the transformed string comprising a bit group from each of the circular shifts;
identifying a location in the transformed string of a bit group from a pre-determined location in the sub-stream;
partitioning the transformed string between the at least two different types of bit groups into transformed string partitions;
compressing the transformed string partitions into compressed transformed string partitions;
outputting the compressed transformed string partitions; and
outputting the location in the transformed string of the bit group from the pre-determined location in the sub-stream.

12. The system of claim 11, wherein the encoder is further configured for:
generating a partition vector that identifies a type of bit group that occurs at each location of the transformed string;
compressing the partition vector to form a compressed partition vector; and
outputting the compressed partition vector.

13. The system of claim 11, wherein the encoder is further configured for:
extracting bit groups of at least one type not included in the sub-stream from the data stream to form a conditional sub-stream;
ordering the conditional sub-stream responsive to an order of the sorted list of circular shifts to form a transformed conditional string;
compressing the transformed conditional string to form a compressed transformed conditional string; and
outputting the compressed transformed conditional string.

14. The system of claim 11, wherein the encoder is further configured for:
extracting bit groups of at least one type not included in the sub-stream from the data stream to form a second sub-stream;
generating circular shifts of the second sub-stream;
sorting the circular shifts of the second sub-stream into second sub-stream sorted circular shifts;
extracting a second transformed string from the second sub-stream sorted circular shifts, the transformed string comprising a bit group from each of the circular shifts of the second sub-stream;
compressing the second transformed string to form a compressed second transformed string; and
outputting the compressed second transformed string.

15. The system of claim 11, wherein the transformed string is formed from a last bit group in each sorted circular shift of the sub-stream.

16. The system of claim 11, wherein the encoder is further configured for compressing the location in the transformed string of the bit group from the pre-determined location in the sub-stream prior to outputting the location.

17. The system of claim 11, wherein the data stream comprises floating-point numbers, and the plurality of different bit group types include an exponent type and a plurality of mantissa types.

18. A computer program product comprising:
a tangible storage medium readable by a processing circuit and storing instructions for execution by the processing circuit for performing a method comprising:
receiving a data stream comprising a plurality of different types of bit groups;
extracting bit groups of at least two different types from the data stream to form a sub-stream;
generating circular shifts of the sub-stream;
sorting the circular shifts of the sub-stream to form a sorted list of circular shifts;
extracting a transformed string from the sorted list of circular shifts, the transformed string comprising a bit group from each of the circular shifts;
identifying a location in the transformed string of a bit group from a pre-determined location in the sub-stream;
partitioning the transformed string between the at least two different types of bit groups into transformed string partitions;
compressing the transformed string partitions into compressed transformed string partitions;
outputting the compressed transformed string partitions; and
outputting the location in the transformed string of the bit group from the pre-determined location in the sub-stream.

19. The computer program product of claim 18, wherein the method further comprises:
generating a partition vector that identifies a type of bit group that occurs at each location of the transformed string;
compressing the partition vector to form a compressed partition vector; and
outputting the compressed partition vector.

20. The computer program product of claim 18, wherein the method further comprises:
extracting bit groups of at least one type not included in the sub-stream from the data stream to form a conditional sub-stream; ordering the conditional sub-stream responsive to an order of the sorted list of circular shifts to form a transformed conditional string;
compressing the transformed conditional string to form a compressed transformed conditional string; and
outputting the compressed transformed conditional string.

21. The computer program product of claim 18, wherein the method further comprises:
extracting bit groups of at least one type not included in the sub-stream from the data stream to form a second sub-stream;
generating circular shifts of the second sub-stream;
sorting the circular shifts of the second sub-stream into second sub-stream sorted circular shifts;
extracting a second transformed string from the second sub-stream sorted circular shifts, the second transformed string comprising a bit group from each of the circular shifts of the second sub-stream;
compressing the second transformed string to form a compressed second transformed string; and
outputting the compressed second transformed string.

22. A method comprising:
receiving a data stream comprising a plurality of different types of bit groups;
extracting a training segment from the data stream;
compressing the training segment using a plurality of different compression algorithms, wherein at least one of the compression algorithms extracts bit groups of one or more types from the training segment to form a first sub-stream, generates a transformed sub-stream using circular shift generation and lexicographic sorting, partitions the transformed sub-stream responsive to bit-group type, compresses the partitions, extracts bit-groups of a type not included in the first sub-stream, orders the extracted bit-groups of a type not included in the first sub-stream in response to an ordering of the transformed sub-stream, and compresses the ordered bit-groups;
determining an actual compression rate and an actual compression speed for each of the different compression algorithms responsive to the compressing;
selecting a compression algorithm for the data stream from the plurality of different compression algorithms, the selecting responsive to the actual compression rate, the actual compression speed and at least one of a target compression rate and a target compression speed; and
compressing the data stream using the selected compression algorithm for the data stream.

23. The method of claim 22, wherein the extracting and compressing the training segment, and the selecting a compression algorithm are performed on a periodic basis.

24. The method of claim 22, wherein the extracting and compressing the training segment, and selecting a compression algorithm are performed in response to changes in at least one of the actual compression rate and the actual compression speed.

25. A method comprising:
receiving a data stream comprising a plurality of different types of bit groups;
extracting bit groups of one type from the data stream to form a sub-stream;
generating circular shifts of the sub-stream;
sorting the circular shifts of the sub-stream to form a sorted list of circular shifts;
extracting a transformed string from the sorted list of circular shifts, the transformed string comprising a bit group from each of the circular shifts;
identifying a location in the transformed string of a bit group from a pre-determined location in the sub-stream;
compressing the transformed string to form a compressed transformed string;
outputting the compressed transformed string;
outputting the location in the transformed string of the bit group from the pre-determined location in the sub-stream;
extracting bit groups of at least one type not included in the sub-stream from the data stream to form a conditional sub-stream;
ordering the conditional sub-stream responsive to an order of the sorted list of circular shifts to form a transformed conditional string;
compressing the transformed conditional string to form a compressed transformed conditional string; and
outputting the compressed transformed conditional string.

26. A method comprising:
receiving a data stream comprising a plurality of different types of bit groups;
extracting bit groups of one type from the data stream to form a sub-stream;
generating circular shifts of the sub-stream;
sorting the circular shifts of the sub-stream to form a sorted list of circular shifts;
extracting a transformed string from the sorted list of circular shifts, the transformed string comprising a bit group from each of the circular shifts;
identifying a location in the transformed string of a bit group from a pre-determined location in the sub-stream;
compressing the transformed string to form a compressed transformed string;
outputting the compressed transformed string;
outputting the location in the transformed string of the bit group from the pre-determined location in the sub-stream;
extracting bit groups of at least one type not included in the sub-stream from the data stream to form a second sub-stream;
generating circular shifts of the second sub-stream;
sorting the circular shifts of the second sub-stream into second sub-stream sorted circular shifts;
extracting a second transformed string from the second sub-stream sorted circular shifts, the second transformed string comprising a bit group from each of the circular shifts of the second sub-stream;
compressing the second transformed string to form a compressed second transformed string; and
outputting the compressed second transformed string.
